(19) United States
(12) Patent Application Publication
(10) Pub. No.: US 2015/0213443 A1
(43) Pub. Date: Jul. 30, 2015

(54) TOKENIZING AUTHORIZATIONS

(71) Applicant: APPLE INC., CUPERTINO, CA (US)

(72) Inventors: Michael H. Geffon, Los Gatos, CA (US); Amanda L. Robinson, San Jose, CA (US)

(73) Assignee: APPLE INC., CUPERTINO, CA (US)

(21) Appl. No.: 14/169,024

(22) Filed: Jan. 30, 2014

(51) Int. Cl. G06Q 20/38; G06Q 20/40

(52) U.S. Cl. CPC G06Q 20/3821; G06Q 20/40; G06Q 2220/00

(57) ABSTRACT

Disclosed herein are systems, methods, and non-transitory computer-readable storage media for creating sharable tokens that point to financial information stored in a secure online platform and that can be used in financial transactions.

### BACKGROUND

1. Technical Field

The present disclosure relates to creating sharable tokens and using the same to complete transactions.

2. Introduction

Delegating purchasing authority to another person can include allowing the merchant to conduct transactions with a cardholder's delegate by the merchant using recorded financial information. For example, some merchants offer to keep a person or business's financial card information on file so that the cardholder or his delegate can complete transactions with the merchant without a financial card being present. However, this practice carries a high risk for abuse and is also expressly forbidden by some financial card security standard bodies, such as the Payment Card Industry Data Security Standard.

Other approaches to transferring purchasing authority to delegates include distributing company credit cards to employees or paying for a specific item in advance and authorizing a delegate pick up the item at a retail location. However, company credit cards can carry a high administrative cost and can also involve a high risk that employees will abuse their authority. In-store pickup approaches do not allow delegates to make purchasing decisions for themselves and are typically limited in whom (e.g. only one expressly identified delegate) can pick up the products.

Other approaches for allowing delegates to make purchasing decisions involve issuing gift cards to delegates and simply handing out cash. However, giving out gift cards or cash to a delegate is wrought with opportunities for misappropriation, theft by another, etc. Furthermore, handing out gift cards or cash in a business environment does not allow for adequate accounting, accountability, ability to depreciate goods, etc.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for creating sharable tokens that point to financial information stored in a secure online platform and that can be used in financial transactions.

The disclosed technology can involve a user authenticating himself with a tokenization service and requesting a token that points to the user's financial information. The tokenization service can encode the financial information into a token and send it to the user. Then, the token can be decoded and used to carry out transactions. The token can also be transferred from the user to one or more delegates and used by the delegate for carrying out transactions. By virtue of the cardholder being uniquely authenticated by the tokenization service, the cardholder device can still view, change, or cancel the token. Consequently, the cardholder maintains ultimate control over the financial information despite the token being transferred and usable by a delegate.

Some embodiments of the present technology involve using a tokenized pre-authorization to enable card-not-present transactions for in-store purchases without requiring the store to keep storing credit card information on file. A tokenization service can request that an external acquiring institution pre-authorize a cardholder and, upon receipt of the pre-authorization, create a transferable, scanable token that points to the pre-authorization. The pre-authorization remains accessible by the cardholder by virtue of the cardholder being uniquely authorized with a tokenization service. Additionally, the cardholder can transfer the token to one or more delegates.

The delegates of the cardholder who receive a tokenized pre-authorization transferred to them have the ability to pay for goods or services of their own choice by using the pre-authorization token like cash. The delegates themselves can also transfer the token to other transferees who can also use the token subject to additional restrictions placed on token by the cardholder.

Some embodiments of the present technology involve systems, methods, and computer-readable media for an online platform to provide tokenization services that include authenticating a cardholder in an online platform and receiving a request from the cardholder for a tokenized pre-authorization for an amount of money from the cardholder's account. The online platform can request the pre-authorization from an acquiring bank and upon receiving the bank's confirmation, create and store a token that can be shared and scanned to complete purchases up to the specified amount.

When the online platform receives a request from a merchant to use the token in a financial transaction at a point-of-sale terminal, the online platform can request that the bank confirm that the authorization identified in the merchant's request is valid and, if so, inform the merchant to proceed with the sale.

Some embodiments of the present technology involve encoding the token with additional security requirements. For example, the token, when scanned, can inform the merchant that the cardholder specified one or more people that are allowed to use the token. As specified by the cardholder, the merchant can then require a photo identification from the delegate using the token. Likewise, the cardholder can request that the tokenization service encode restrictions on how many times the token can be shared, on when or where the token can be used, on what items that token can be used to buy, etc.

Some embodiments involve the token being encoded as a two-dimensional scanable barcode and the barcode being sent to the user and displayed as a digital card in a digital wallet application.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 shows an exemplary method of tokenizing pre-authorizations;

FIG. 2 shows a system for creating, sharing, and redeeming tokenized pre-authorizations according to some embodiments of the disclosed technology;

FIG. 3 shows a flowchart describing the interactions between a client device, merchant device, tokenization service broker, and an acquiring institution when using a tokenized pre-authorization to complete a transaction according to some embodiments of the present technology;

FIG. 4 illustrates an exemplary method of tokenizing a pre-authorization and providing a merchant with a confirmation when a tokenized pre-authorization is used to complete a transaction with a merchant POS system;

FIG. 5A illustrates a graphical representation of tokenized pre-authorizations encoded as two-dimensional bar codes in one or more digital passes in a digital wallet application according to some embodiments of the present technology;

FIG. 5B illustrates a graphical representation of tokenized pre-authorizations encoded as two-dimensional bar codes in one or more digital passes in a digital wallet application according to some embodiments of the present technology;

FIG. 6 illustrates a more generalized method of creating shareable tokenized authorizations according to some embodiments of the present technology;

FIG. 7A illustrates a conventional system bus computing system architecture wherein the components of the system are in electrical communication with each other using a bus; and

FIG. 7B illustrates a computer system having a chipset architecture that can be used in executing the described method and generating and displaying a graphical user interface (GUI).

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The present disclosure addresses the need in the art for ways to allow a cardholder to transfer purchasing authority to delegates for conducting transactions. Some embodiments address the need in the art for ways to uniquely identify a cardholder in order for the cardholder to maintain control over the financial information while also allowing authorized delegates to make individual purchasing decisions without merchants storing financial information and without overhauling merchant point-of-sale infrastructure.

The present disclosure involves systems, methods and non-transitory computer-readable media for creating shareable tokens that point to pre-authorizations or other transactions in an online platform. Some embodiments of the present technology relate to enabling card-not-present transactions for in-store purchases without storing credit card information with a store agent by uniquely authorizing agents of a payer to choose and pay for goods or services using a tokenized pre-authorization. The disclosed technology involves a cardholder authenticating himself with a tokenization service and requesting transferrable tokens that point to financial information or financial transactions, such as pre-authorizations.

The tokenization service can send the cardholder a token that can be decoded at a point-of-sale terminal and used to carry out a purchase. The token can also be transferred from the cardholder to one or more delegates and used by the delegate. Also, by virtue of the cardholder being uniquely authenticated by the tokenization service, the cardholder device can still view, change, or cancel the financial information or transaction encoded into the token. Accordingly, the cardholder maintains ultimate control over the token despite the token being transferred and usable by a delegate.

Some of the following description details tokenizing financial card pre-authorizations for conducting card-not-present transactions between a cardholder/delegate and a merchant; however, a wide variety of other transaction types can benefit from tokenized authorization, as will be explained below. Similarly, some of the description discusses financial cards; however, the technology can be applied to many types of financial account types such as checking accounts, escrow accounts, trusts, direct credit terms, commercial leases, consumer loans, etc.

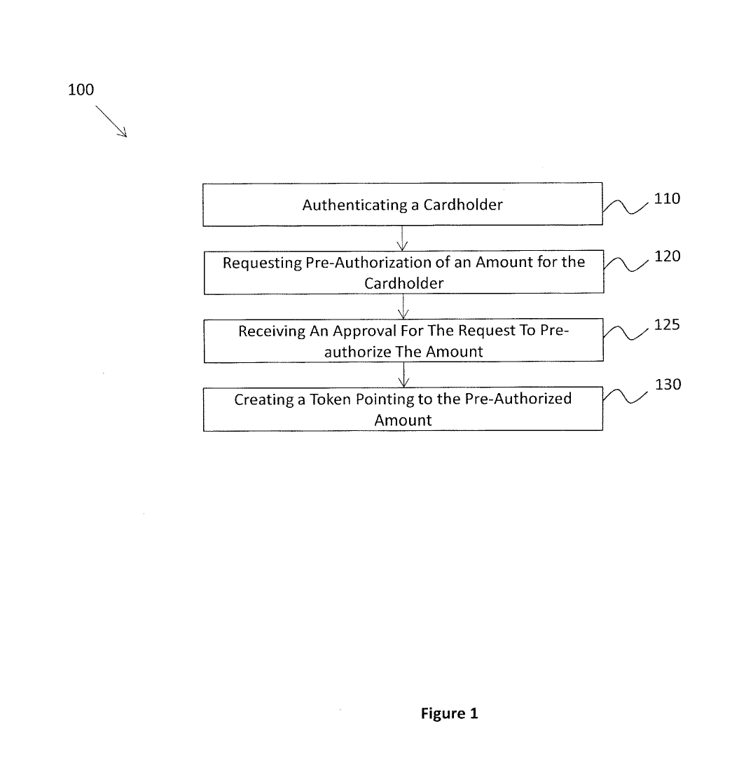

FIG. 1 shows an exemplary method 100 of tokenizing pre-authorizations. The method 100 begins with authenticating a cardholder in an online platform 110. In some embodiments of the disclosed technology, the method 100 can be performed by an online store platform and authenticating a cardholder in the online store platform using username and password credentials for logging into an online store account. For the purpose of this disclosure, the term cardholder shall mean a person or corporate entity whose name appears on a financial card as well as other persons with authority to make purchases using the financial card, e.g. an employee, an accountant, etc.

Next, the method 100 involves requesting pre-authorization of an amount of financial resources that can be charged to the card in a point-of-sale transaction 120. Requesting a pre-authorization can involve requesting a hold on a balance of cash or credit as unavailable either until the merchant clears the transaction or the hold expires. Requesting a pre-authorization on a card can involve submitting a pre-authorization request to an acquiring institution with the cardholder's card details, requested effective dates of the pre-authorization, and maximum amount.

Next, the method 100 involves receiving an approval for the request to pre-authorize the amount 125 and creating a token pointing to the pre-authorized amount 130.

The token can be a portable, transferrable digital code that, when decoded, links the decoding party with the pre-authorization. For example, the token can be a scanable two-dimensional barcode that, when scanned in a retail point-of-sale transaction leads the scanning merchant to the pre-authorization. The token can also take a wide variety of other forms including a Bluetooth Low Energy beacon, a programmable RFID tag, etc.

The merchant can then validate the pre-authorization amount and complete a transaction, as will be discussed in greater detail below.

Although tokenizing pre-authorizations for retail point-of-sale transactions is discussed in detail, those with ordinary skill in the art having the benefit of this disclosure will appreciate that a wide variety of authorization types, now known or later developed, can benefit from being tokenized, thereby allowing the authorizations to be portable and transferable to other parties such that agents, employees, delegates, fiduciaries, etc. can easily act in the place of a principal.

For example, the present technology can be applied to consumer financing transactions, drop off and pickup situations, pre-payment transaction, business-to-business equipment financing transactions with commercial credit partners, business-to-business transactions performed under direct terms negotiated between the parties, pre-approved mortgage lending terms, physician approved prescription refills, etc.

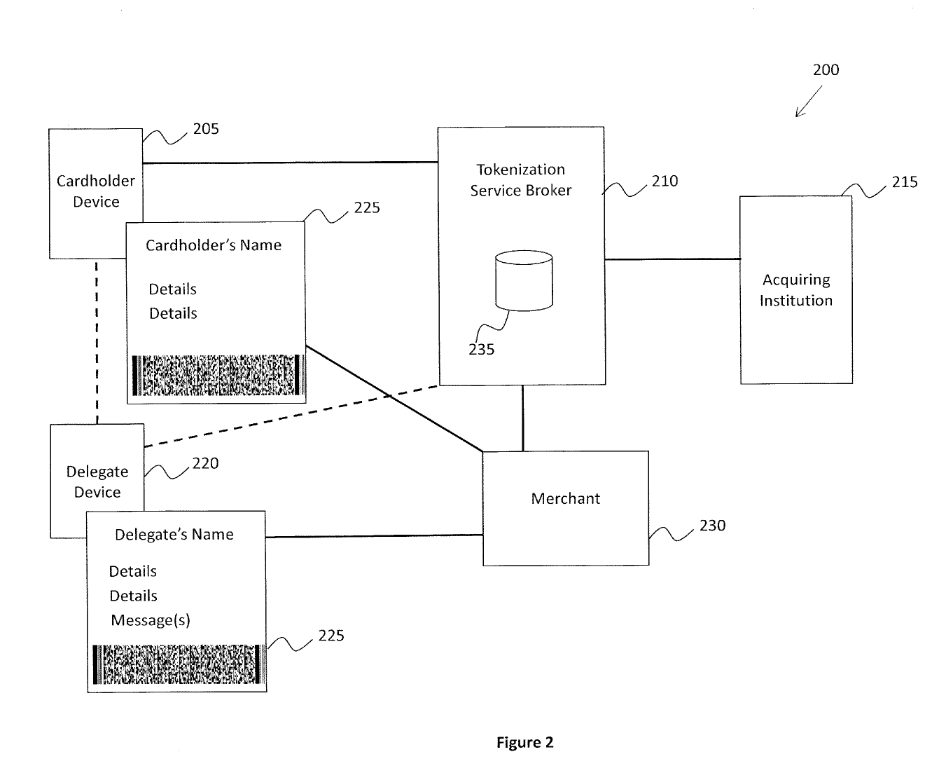

FIG. 2 shows a system 200 for creating, sharing, and redeeming tokenized pre-authorizations according to some embodiments of the disclosed technology. The system 200 includes a tokenization service broker 210. In some embodiments, the tokenization service broker 210 can be part of a larger online platform, such as an online store platform. In some embodiments, the tokenization service broker 210 can manage tokenized pre-authorizations for multiple online entities and can be system agnostic, thereby allowing multiple device types using varying devices, software, operating systems, etc. with the ability to receive and use tokenized pre-authorizations.

The system 200 also involves a cardholder device 205 in communication with the tokenization service broker 210 and the tokenization service broker 210 in communication with an acquiring institution 215. An acquiring institution 215 can process credit and debit card payments for goods and services for merchants. The tokenization service broker 210 can authenticate a user of the cardholder device 205 with a unique identification and password credentials. Once authenticated, the cardholder device 205 can be used to instruct the tokenization service broker 210 to request a pre-authorization from the acquiring institution 215.

When the acquiring institution 215 pre-authorizes an amount for the cardholder, it responds to the tokenization service broker 210 the amount requested has been pre-authorized for the cardholder. The cardholder device 205 can be used to view the pre-authorized amount, optionally add additional other required credentials for using the pre-authorization, e.g. a photo identification, a company badge, etc. Likewise, the cardholder device 205 can be used to manage permissions relating to how the pre-authorized amount may be used to purchase, e.g. classes of items and services, particular items and services, time of day restrictions, geographical restrictions, who can transfer the token (e.g. cardholder, original transferee, subsequent transferee, etc.) a maximum number of times a token can be transferred, etc.

The tokenization service broker 210 can store the pre-authorization, permissions, restrictions, etc. in one or more computer storage location 235. Also, the tokenization service broker 210 can generate a token (aka “tokenize”) based on the stored information. The token can comprise any code that, when decoded, points to pre-authorization. The tokenization service broker 210 can also create token manifests comprising records regarding the pre-authorization, expiration, permissions, restrictions, etc. In some embodiments, tokenizing a pre-authorization involves generating a code that, when decoded, points to the token manifest in the tokenization service broker 210.

In some embodiments, the token 225 comprises a two-dimensional barcode that can be scanned and read by POS barcode readers. In some embodiments of the present technology, the token 225 can be part a graphical user interface (GUI) element containing the token and other details (e.g. a digital pass in a digital wallet application.)

The cardholder device 205 can download the token 225 and can also freely transfer (subject to any restrictions) the token 225 to one or more delegate device 220. Additionally, the cardholder device 205 can be used to specify, to the tokenization service broker 210, one or more delegates who may themselves download the token 225 from the tokenization service broker 210. The token 225 can be downloaded from a website using a web browser, sent via email, send via instant message, sent via SMS, shared over social media, shared via a micro-blogging platform, shared via a photo-sharing platform, etc. When the token 225 is transferred, it can optionally be updated to include the delegate's name, other details about the delegate, permissions, or restrictions that apply to the delegate. Likewise, a transferred token 225 can be accompanied with a message (e.g. in the GUI element, in an email/SMS, etc.). Additionally, other messages can be sent between the cardholder and one or more delegates as changes occur to the pre-authorization (e.g. a pre-authorization is used, transferred, cancelled, closing in on an expiration period, etc.).

The token 225 can be used by a delegate or by another transferee without the transferee knowing the cardholder's authentication credentials. However, after the token 225 is transferred, the cardholder device 205 can still view, change, cancel the token 225 or the pre-authorization itself by virtue of being authenticated with the tokenization service broker 210. Conversely, a bad actor (e.g. an embezzling employee, a thief of a delegate's device, etc.) cannot change the pre-authorization amount, lock out the cardholder, etc. because the bad actor would need the authentication credentials used by the cardholder.

The cardholder or delegate can present the token 225 to a merchant in lieu of other forms of payment. Indeed, as shown in FIG. 2, the system 200 also includes a merchant device 230 that can read the token 225 and request verification of the pre-authorization from the tokenization service broker 210. The tokenization service broker 210 can transmit a message back to the merchant device 230 asking for additional credentials (e.g. a photo identification, company badge, etc.) and can request that the acquiring institution 215 validate the pre-authorization and issue an actual authorization. When the tokenization service broker 210 receives validation and actual authorization from the acquiring institution, it can send authorization clearance to the merchant device 230 to complete the transaction. In some embodiments of the disclosed technology, an authorization clearance received by the merchant device 230 can comprise a simple instruction (“Yes” or “No,” Green Light or Red Light, etc.) such that the retail store operator of the merchant device 230 does not have to be trained on how to interpret a token 225 or have to worry about whether the transaction was actually processed. Also, the tokenization service broker 210 can log an authorization clearance in the computer storage location 235 and send messages to the various parties. For example, the tokenization service broker 210 can send the cardholder device 205 a notification detailing when a token 225 is used by a delegate device 220, the delegate's name, how much of the pre-authorized amount was used, etc.

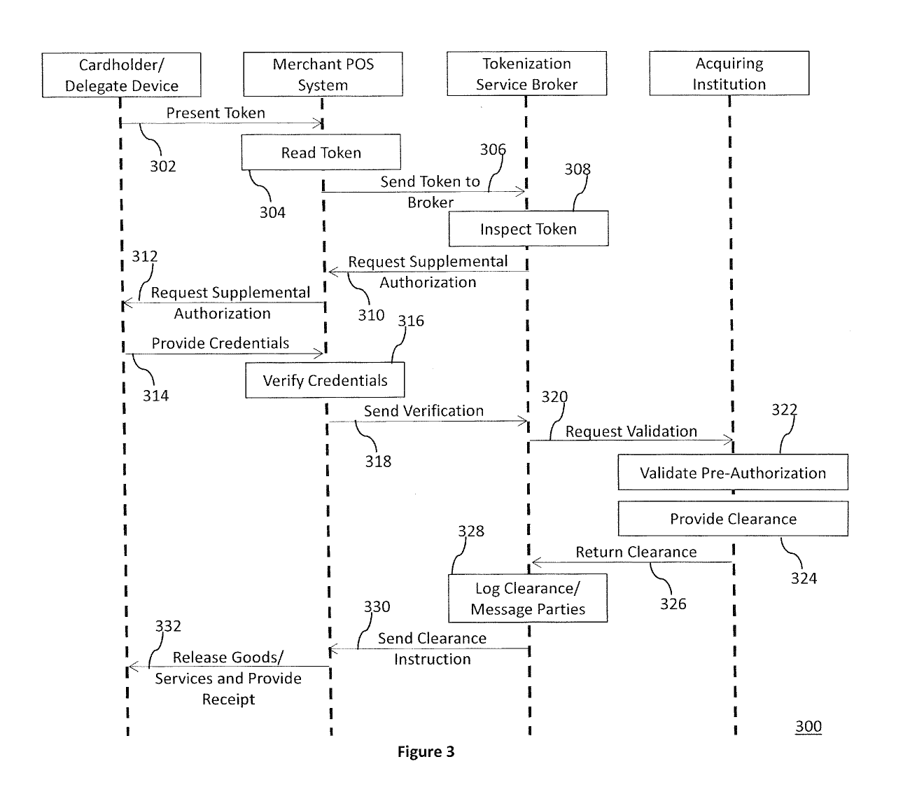

FIG. 3 shows a flowchart 300 describing the interactions between a client device, merchant device, tokenization service broker, and an acquiring institution when using a tokenized pre-authorization to complete a transaction according to some embodiments of the present technology. The interactions begin with a cardholder or delegate device presenting a token 302 to a merchant POS system and requesting that the POS system validate the token. The POS system reads the token 304 and makes a request to the tokenization service broker to inspect and validate the token 306. The tokenization service broker inspects the token 308. Inspecting the token can involve inspecting the token's format and date, determining whether the token is valid and not revoked or cancelled. Inspecting the token can also involve expanding a token manifest to determine whether any supplemental authorization information (e.g. photo identification, company badge, etc.) is required before requesting a validation from an acquiring institution. If so, the tokenization service broker requests that the merchant POS system verify the cardholder or delegate has the supplemental authorization 310. The merchant POS system requests that the cardholder or delegate produce the supplemental authorization 312 and the cardholder or delegate can provide the requisite credentials 314. The merchant POS system can verify the credentials (e.g. visually inspecting credentials, swiping an identification card, etc.) 316 and send verification to the tokenization service broker 318.

Next, the tokenization service broker requests validation of the pre-authorization from the acquiring institution 320. Requesting validation from the acquiring institution can involve informing the acquiring institution that a cardholder/delegate presented a tokenized pre-authorization to a merchant and requesting that the acquiring institution confirm that the pre-authorization is still valid.

The acquiring institution can validate the pre-authorization 322, provide clearance 324, and return the clearance 326 to the tokenization service broker. Optionally, the tokenization service broker can log the clearance and send messages/notifications to the cardholder, delegate etc. 328.

The tokenization service broker can send a clearance instruction to the merchant POS system 330. Upon receiving a clearance, the merchant POS can release the goods or render the services and provide a receipt 332.

FIGS. 2 and 3 discuss an acquiring institution authorizing financial information for the tokenization service broker; however, those with ordinary skill in the art having the benefit of this disclosure will appreciate that a tokenization service itself can provide financial services. For example, a tokenization service can be a part of an online store that offers its own financial services such as lease terms, business-to-business direct terms, etc.

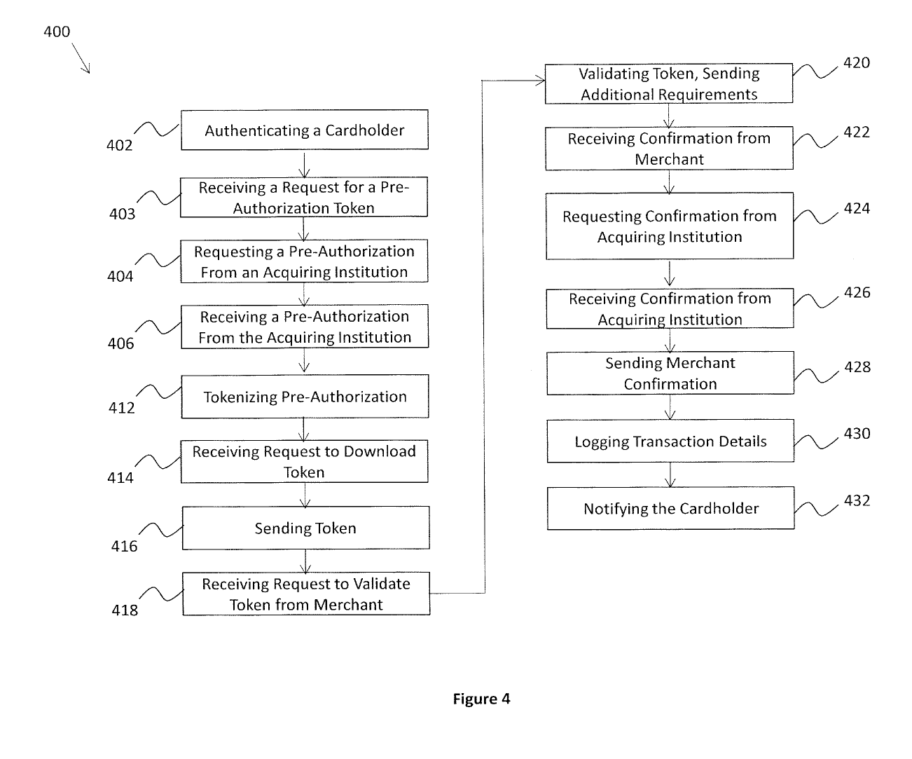

FIG. 4 illustrates an exemplary method 400 of tokenizing a pre-authorization and providing a merchant with a confirmation when a tokenized pre-authorization is used to complete a transaction with a merchant POS system. First, the method 400 involves authenticating a cardholder 402. For example, authenticating a cardholder 402 can involve receiving credentials for logging into an online store platform. Once a cardholder is authenticated, the method 400 can involve receiving a request for a pre-authorization token 403 from the cardholder. The request can specify an amount of money, additional requirements for using the pre-authentication token (e.g. photo identification, company badge, etc.), limits on a number of times a token can be transferred, a limit on how long a token can remain valid without automatically being revoked, etc.

Next, the method 400 involves requesting a pre-authorization for an amount of money specified in a pre-authorization request from an acquiring institution 404 and receiving a pre-authorization from the acquiring institution 406. Once the pre-authorization is received, the method 400 involves tokenizing the pre-authorization 412.

After a token is generated, the method 400 can involve receiving a request from a cardholder to download the token 414 and sending the token to the cardholder or a specified delegate 416.

Next, the method 400 involves receiving a request from a merchant to validate the token 418 to complete a purchase. The method 400 then involves validating the token and sending any additional requirements to the merchant 420. Upon receiving a confirmation from the merchant 422, the method 400 involves requesting confirmation from the acquiring institution 424 and receiving confirmation from the acquiring institution 426.

Upon receiving confirmation from the acquiring institution, the method 400 involves sending the merchant with a confirmation 428 that the token is valid and that the acquiring institution actually authorized the transaction. Finally, the method 400 involves logging transaction details 430 and notifying the cardholder with the details of the transaction 432.

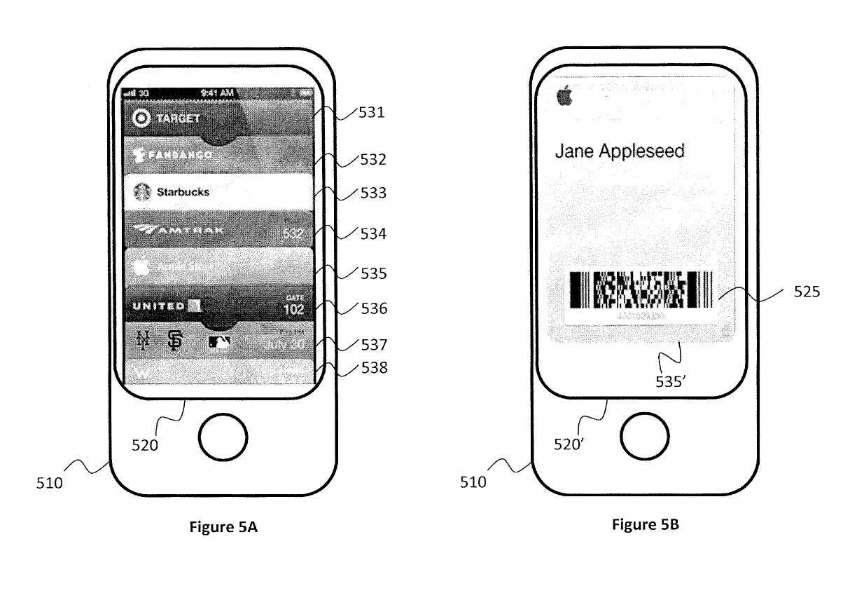

As explained above, a tokenized pre-authentication can be part a graphical user interface (GUI) element containing the token and other details. For example, a tokenized pre-authentication can be a two-dimensional bar code displayed in a digital pass in a digital wallet application. FIGS. 5A and 5B illustrate graphical representations of tokenized pre-authorizations encoded as two-dimensional bar codes in one or more digital passes in a digital wallet application according to some embodiments of the present technology.

FIG. 5A shows an electronic device 510 displaying a graphical user interface 520 of a digital wallet application being executed on the electronic device 510. The graphical user interface 520 displays representations of a plurality of passes 531, 532, 533, 534, 535, 536, 537, 538 that can be selected, expanded, and used to conduct transactions for a wide variety of goods and services, e.g. retail, point-of-entry ticket takers, transportation services, loyalty program services, accommodation reservations, etc. Also, a pass 535 can be selected and used for displaying a tokenized pre-authorization.

FIG. 5B shows an electronic device 510 displaying a graphical user interface 520′ of a digital wallet application being executed on the electronic device 510. The graphical user interface 520′ displays a digital pass 535′ with a tokenized pre-authorization 525.

As explained above, current solutions for delegating purchasing authority (e.g. company credit cards, gift cards, in-store pickup, etc.) are lacking in many respects. Accordingly, some embodiments of the present technology involve tokenized pre-authorizations being used as a cash-equivalent for members of the organization to conduct business on behalf of the organization while avoiding the pitfalls of previous solutions by allowing tokens to be transferable while remaining accessible by the cardholder.

Likewise, tokenized pre-authorizations can be used in conjunction with an organization's enterprise software. As explained above, a tokenization service broker can log details of a transaction that is conducted using a tokenized pre-authorization. If an organization's enterprise software can interface (e.g. through an API) with the tokenization service broker, it can incorporate the transaction details as structured data. The details of the transactions can then be used by accounting departments for billing, expense reports, depreciation of equipment, etc.

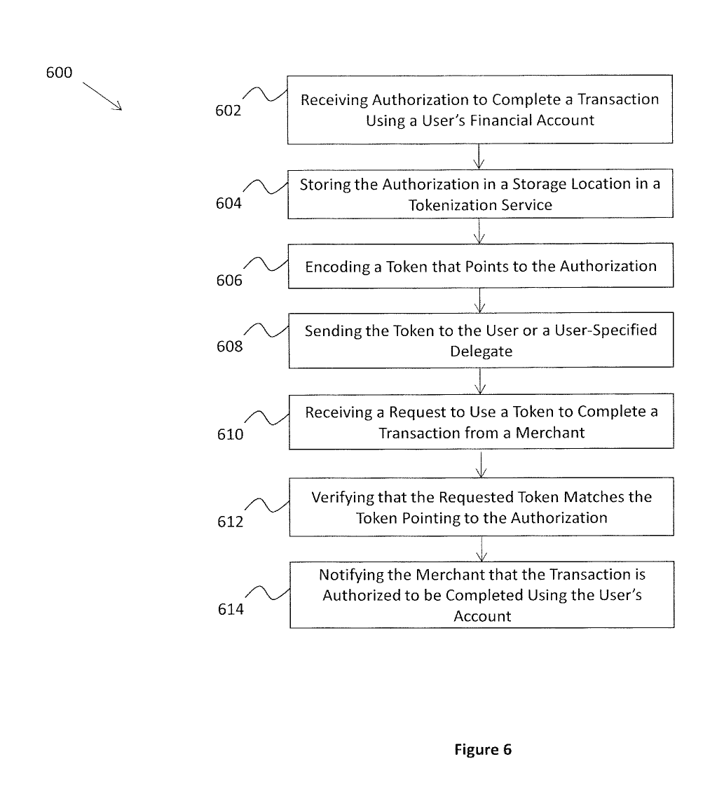

Some of the foregoing description details card-not-present transactions made between a cardholder/delegate and a merchant; however, a wide variety of other transaction types can benefit from tokenized authorization. FIG. 6 illustrates a more generalized method 600 of creating shareable tokenized authorizations according to some embodiments of the present technology.

The method 600 of FIG. 6 involves a tokenization server receiving authorization to complete a transaction using a user's financial account 602. The authorization can be received from an external acquiring institution as explained above, from another other external financial institution, from an online store associated with the tokenization service, etc.

Once an authorization is received, the tokenization service stores the authorization 604 and encodes a token that points to the authorization 606. According to various embodiments of the disclosed technology, the token can take many forms. For example, the token can comprise an alphanumeric code, a visual coupon, a graphical barcode, a dongle that generates a dynamic passcode, etc. In a specific example, as explained above, the token can comprise a scanable graphical interface element that can be shared between the user and one or more delegates. Also as explained above, the token can be encoded with additional features that describe additional security requirements pertaining to how the token can be transferred and pertaining to additional credentials that can be required to use the token to complete a transaction. The exemplary method 600 also involves sending the token to the user or one or more delegates 608.

Next, the method 600 involves the tokenization service receiving a request to use the token to complete a transaction from a merchant 610. According to various embodiments of the disclosed technology, the request can originate in a wide variety of scenarios. For example, the request can involve the user himself using the token, a user transferring the token to a delegate and the delegate using the token, the user giving the token as a reward in a customer loyalty scenario, etc.

Once the tokenization service receives the token along with a request to use the token to complete a transaction, the method 600 can involve verifying that the token used in the request matches a token stored in the tokenization service that points to an authorization 612. Next, if the token is valid, if an external institution is used and verifies the token, and any additional security requirements are met, the method involves the tokenization service notifying the merchant that the transaction is authorized to be completed using the user's financial account 614.

As explained above, tokenized authorization can be applied to a wide variety of transaction types. In some cases the disclosed technology can improve the process of consumers applying for and businesses providing consumer financing for purchases. For example, a consumer can apply for financing directly with a manufacturer of a product while the consumer is home or in another convenient location. The manufacturer can approve the financing application, tokenize the approval, and send the token to the consumer. The consumer or a delegate can then bring that token to any retail location that sells the manufacturer's products and use the token to effect a purchase of the manufacturer's products without having to apply for financing with the particular store.

The disclosed technology can also be used in drop off and pickup situations. Currently, there is not an easy way for shops (e.g. a repair shop, pawn shop, etc.) to know whether a person dropping off a product for later pickup is actually authorized to possess the product or if he is a thief. Some embodiments of the present technology involve an owner of a product creating a drop-off/and pickup slip using an online platform, the platform tokenizing the slip, and the platform sending the owner a transferable token. The owner can send the token to a delegate for using the token to perform the task of dropping off and picking up. The shop can decode the token to see that the delegate is authorized to drop the product off and pick it up.

Some embodiments of the present technology involve an online platform receiving a request from a cardholder to process a pre-payment transaction and deliver a token pointing to the pre-payment. The cardholder can then use the token when making purchases in physical stores. The cardholder can also distribute the token to one or more delegates and subject the token's to restrictions to limit the delegate's ability to use the token to make purchases at a merchant's physical store. For example, a parent cardholder can distribute pre-payment tokens to children and subject the tokens to restrictions for when the tokens can be used, how much can be drawn from the pre-payment amount pointed to by the token, specific items that the token can be used for (e.g. school books), specific items that cannot be purchased using the tokens (e.g. alcohol), what types of merchants the token can be used for, a specific region that the token can be used, etc.

Tokenized pre-authorizations can be used as payment type for many different business-to-business transactions. For example, tokenized pre-authorizations can be used for equipment financing transactions with commercial credit partners. In some embodiments, a business can apply for a commercial lease from an equipment company, the equipment company can approve and can tokenize the approval and send the token(s) to the business to distribute to its employees. The business and the equipment company can also specify buying guidelines to reflect the terms of the lease and the terms can be encoded in the token. Accordingly, the employees of the business can use the tokens to purchase equipment of their own choosing so long as it covered by the lease terms. On the other side of the transaction, the employee of the equipment company conducting the point-of-sale transaction does not need to be familiar with the business's negotiated terms; rather, the token either works to complete a transaction or not.

Similarly, some business-to-business transactions are performed under direct terms negotiated between the parties. Some embodiments of the present technology involve allowing for the creation of direct term tokens that can be read by a retail point-of-sale terminal and decoded so that the point-of-sale employee does not need to request approval from a supervisor, lookup the direct terms, etc.

Furthermore, some organizations can involve tiers of purchase authorization that can be tokenized. For example, an organization can provide managers with tokens for a premium device and can provide other employees with tokens for standard devices.

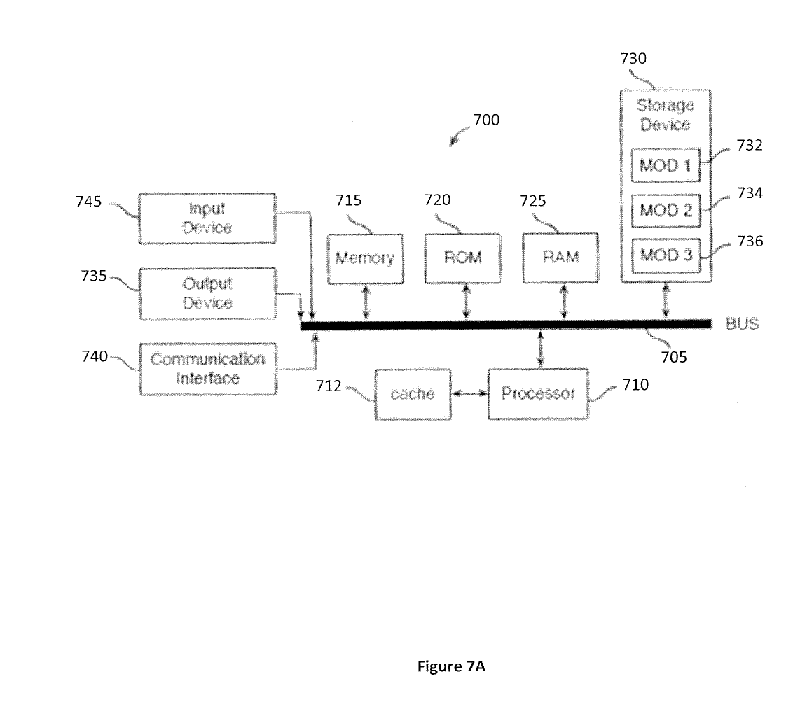

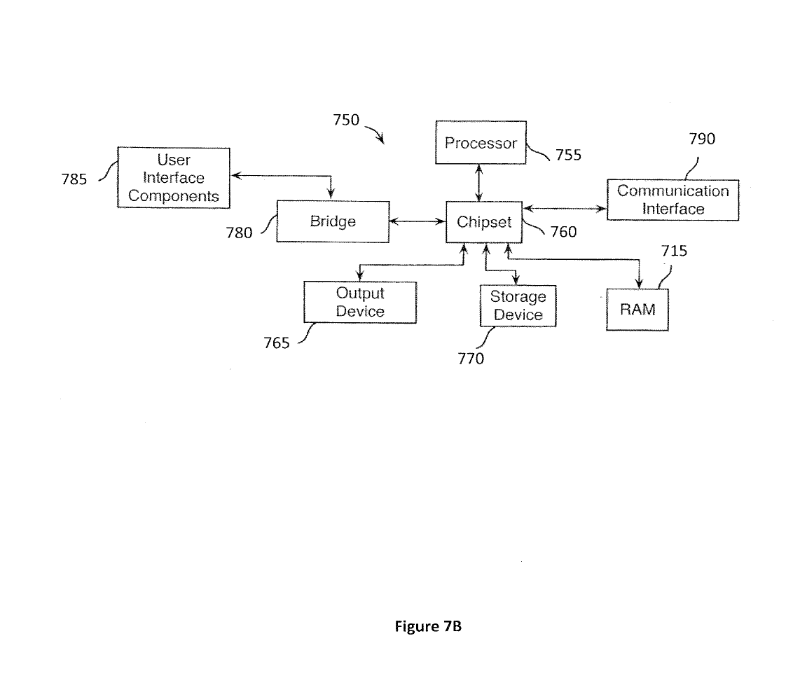

FIG. 7A and FIG. 7B illustrate exemplary possible system embodiments. The more appropriate embodiment will be apparent to those of ordinary skill in the art when practicing the present technology. Persons of ordinary skill in the art will also readily appreciate that other system embodiments are possible.

FIG. 7A illustrates a conventional system bus computing system architecture 700 wherein the components of the system are in electrical communication with each other using a bus 705. Exemplary system 700 includes a processing unit (CPU or processor) 710 and a system bus 705 that couples various system components including the system memory 715, such as read only memory (ROM) 720 and random access memory (RAM) 725, to the processor 710. The system 700 can include a cache of high-speed memory connected directly with, in close proximity to, or integrated as part of the processor 710. The system 700 can copy data from the memory 715 and/or the storage device 730 to the cache 712 for quick access by the processor 710. In this way, the cache can provide a performance boost that avoids processor 710 delays while waiting for data. These and other modules can control or be configured to control the processor 710 to perform various actions. Other system memory 715 may be available for use as well. The memory 715 can include multiple different types of memory with different performance characteristics. The processor 710 can include any general purpose processor and a hardware module or software module, such as module 1 732, module 2 734, and module 3 736 stored in storage device 730, configured to control the processor 710 as well as a special-purpose processor where software instructions are incorporated into the actual processor design. The processor 710 may essentially be a completely self-contained computing system, containing multiple cores or processors, a bus, memory controller, cache, etc. A multi-core processor may be symmetric or asymmetric.

To enable user interaction with the computing device 700, an input device 745 can represent any number of input mechanisms, such as a microphone for speech, a touch-sensitive screen for gesture or graphical input, keyboard, mouse, motion input, speech and so forth. An output device 735 can also be one or more of a number of output mechanisms known to those of skill in the art. In some instances, multimodal systems can enable a user to provide multiple types of input to communicate with the computing device 700. The communications interface 740 can generally govern and manage the user input and system output. There is no restriction on operating on any particular hardware arrangement and therefore the basic features here may easily be substituted for improved hardware or firmware arrangements as they are developed.

Storage device 730 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 725, read only memory (ROM) 720, and hybrids thereof.

The storage device 730 can include software modules 732, 734, 736 for controlling the processor 710. Other hardware or software modules are contemplated. The storage device 730 can be connected to the system bus 705. In one aspect, a hardware module that performs a particular function can include the software component stored in a computer-readable medium in connection with the necessary hardware components, such as the processor 710, bus 705, display 735, and so forth, to carry out the function.

FIG. 7B illustrates a computer system 750 having a chipset architecture that can be used in executing the described method and generating and displaying a graphical user interface (GUI). Computer system 750 is an example of computer hardware, software, and firmware that can be used to implement the disclosed technology. System 750 can include a processor 755, representative of any number of physically and/or logically distinct resources capable of executing software, firmware, and hardware configured to perform identified computations. Processor 755 can communicate with a chipset 760 that can control input to and output from processor 755. In this example, chipset 760 outputs information to output 765, such as a display, and can read and write information to storage device 770, which can include magnetic media, and solid state media, for example. Chipset 760 can also read data from and write data to RAM 775. A bridge 780 for interfacing with a variety of user interface components 785 can be provided for interfacing with chipset 760. Such user interface components 785 can include a keyboard, a microphone, touch detection and processing circuitry, a pointing device, such as a mouse, and so on. In general, inputs to system 750 can come from any of a variety of sources, machine generated and/or human generated.

Chipset 760 can also interface with one or more communication interfaces 790 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 755 analyzing data stored in storage 770 or 775. Further, the machine can receive inputs from a user via user interface components 785 and execute appropriate functions, such as browsing functions by interpreting these inputs using processor 755.

It can be appreciated that exemplary systems 700 and 750 can have more than one processor 710 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, tablet computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

We claim:

1. A computer-implemented method comprising:
storing, in a computer storage location, an authorization for a financial transaction type to be completed using a user's financial account;
encoding a token that, when decoded, points to the authorization in the computer storage location;
making the token available to a party designated by the user;
receiving, from a merchant, a request to complete a specific transaction using a decoded token;
verifying that the decoded token matches the token that points to the authorization stored in the computer storage location and that the specific transaction corresponds with the financial transaction type described in the authorization; and
notifying the merchant that the transaction is authorized to be completed using the user's financial account.

2. The computer-implemented method of claim 1, wherein the party designated by the user is selected from among the user and one or more delegates specified by the user.

3. The computer-implemented method of claim 1, further comprising:
receiving, from the user, a request to pre-authorize user's financial account for the financial transaction type; and
receiving the authorization in the form of an approval to pre-authorize the user's financial account for the financial transaction type.

4. The computer-implemented method of claim 3, further comprising:
requesting an external acquiring institution pre-authorize the user's financial account for the financial transaction type; and
receiving the approval from the external acquiring institution.

5. The computer-implemented method of claim 4, further comprising:
requesting that the external acquiring institution verify that the specific transaction corresponds with the financial transaction type described in the authorization; and
receiving confirmation from the external acquiring institution that the specific transaction is authorized.

6. The computer-implemented method of claim 1, further comprising:
receiving, from the user, a request that an additional requirement be imposed for using the token to complete a transaction,
wherein encoding the digital token further comprises encoding the additional requirement into the token.

7. The computer-implemented method of claim 6, further comprising:
receiving, from a merchant, verification that the request to complete a specific transaction using the decoded token is made by a party that fulfills the additional requirement.

8. The computer-implemented method of claim 6, wherein the additional requirement comprises a requirement that the request to complete a specific transaction using the decoded token must be made by a party having specified credentials.

9. The computer-implemented method of claim 6, wherein the additional requirement comprises a limit on the number of times a token can be transferred.

10. The computer-implemented method of claim 1, further comprising:
receiving, from the merchant, confirmation that the transaction is completed using the user's financial account; and
notifying the user that the transaction was completed using the user's financial account.

11. The computer-implemented method of claim 1, wherein encoding a token further comprises:
creating a scanable code that represents the token; and
sending an instruction to an electronic device associated with the user, the instruction causing the electronic device to display a graphical element containing the scanable code.

12. A computer-implemented method of comprising:
authenticating a cardholder in an online platform;
receiving a request from the cardholder for a tokenized pre-authorization for an amount of financial resources from a financial account of the cardholder;
requesting a pre-authorization from an acquiring institution, the pre-authorization including the amount of financial resources from a financial account of the cardholder;
receiving the pre-authorization from an acquiring institution;
storing the pre-authorization in a computer storage location in the online platform;
creating a transferable digital token that points to the pre-authorization in the computer storage location and that can be scanned to complete a financial transaction for up to the amount of financial resources;
receiving, from a merchant, a request to use the token in a financial transaction at a point-of-sale terminal;
requesting, from the acquiring institution, confirmation that the financial account of the cardholder is still able to perform the financial transaction;
receiving confirmation from the acquiring institution that the transaction is authorized; and
notifying the merchant at the point-of-sale terminal that the transaction is authorized.

13. The computer-implemented method of claim 12, wherein creating a transferable digital token further comprises:
creating a scanable code that represents the token; and
sending an instruction to an electronic device associated with the cardholder, the instruction causing the electronic device to display a graphical element containing the scanable code.

14. The computer-implemented method of claim 12, further comprising:
receiving, from the cardholder, an additional security requirement for using the transferable digital token, and
wherein creating a transferable digital token further comprises encoding information relating to the additional security requirement into the transferable digital token.

15. The computer-implemented method of claim 14, further comprising:
upon receiving a request to use the token in a financial transaction from a merchant;
requesting confirmation from the merchant that the additional security requirement is satisfied; and
receiving confirmation from the merchant that the additional security requirement is satisfied.

16. The computer-implemented method of claim 14, wherein the additional security requirement comprises a requirement that the merchant confirm that the request to use the token in a financial transaction at a point-of-sale terminal is made by a party having specified credentials.

17. The computer-implemented method of claim 14, wherein the additional security requirement comprises a limit on the number of times a token can be transferred.

18. A non-transitory computer-readable storage medium comprising:
a medium configured to store computer-readable instructions thereon; and
the computer-readable instructions that, when executed by a processing device cause the processing device to perform a method, comprising:
authenticating a cardholder in an online platform;
receiving a request from the cardholder for a tokenized pre-authorization for an amount of financial resources from a financial account of the cardholder;
requesting a pre-authorization from an acquiring institution, the pre-authorization including the amount of financial resources from a financial account of the cardholder;
receiving the pre-authorization from an acquiring institution;
storing the pre-authorization in a computer storage location in the online platform;
creating a transferable digital token that points to the pre-authorization in the computer storage location and that can be scanned to complete a financial transaction for up to the amount of financial resources;
receiving, from a merchant, a request to use the token in a financial transaction at a point-of-sale terminal;
requesting, from the acquiring institution, confirmation that the financial account of the cardholder is able to perform the financial transaction;
receiving confirmation from the acquiring institution that the transaction is authorized; and
notifying the merchant at the point-of-sale terminal that the transaction is authorized.

19. The non-transitory computer-readable storage medium of claim 18, wherein creating a transferable digital token further comprises:
creating a scanable code that represents the token; and
sending an instruction to an electronic device associated with the cardholder, the instruction causing the electronic device to display a graphical element containing the scanable code.

20. The non-transitory computer-readable storage medium of claim 18, and the instructions further causing the processing device to perform the steps of:
receiving, from the cardholder, an additional security requirement for using the transferable digital token, and
wherein creating a transferable digital token further comprises encoding information relating to the additional security requirement into the transferable digital token.

21. The non-transitory computer-readable storage medium of claim 20, and the instructions further causing the processing device to perform the steps of:
upon receiving a request to use the token in a financial transaction from a merchant;
requesting confirmation from the merchant that the additional security requirement is satisfied; and
receiving confirmation from the merchant that the additional security requirement is satisfied.

22. The non-transitory computer-readable storage medium of claim 20, wherein the additional security requirement comprises a requirement that the merchant confirm that the request to use the token in a financial transaction at a point-of-sale terminal is made by a party having specified credentials.

23. The non-transitory computer-readable storage medium of claim 20, wherein the additional security requirement comprises a limit on the number of times a token can be transferred.

24. A system comprising:
a network interface configured to receive an authorization for a financial transaction type to be completed using a user's financial account from an external acquiring institution;
a memory storage location configured to store the authorization for a financial transaction type to be completed using a user's financial account;
a processor;
a processor configured to encode a token that, when decoded, points to the authorization in the computer storage location;
the network interface is further configured to:
make the token available to a party designated by the user; and
receive, from a merchant, a request to complete a specific transaction using a decoded token;
the processor further configured to:
verify that the decoded token matches the token that points to the authorization stored in the computer storage location; and
verify that the specific transaction corresponds with the financial transaction type described in the authorization; and
the network interface further configured to notify the merchant that the transaction is authorized to be completed using the user's financial account.

25. The system of claim 24, wherein the party designated by the user is selected from among the user and one or more delegates specified by the user.

26. The system of claim 24, wherein the network interface is further configured to:
receive, from the user, a request to pre-authorize user's financial account for the financial transaction type; and
receiving the authorization in the form of an approval to pre-authorize the user's financial account for the financial transaction type.

27. The system of claim 24, wherein the network interface is further configured to:
request that the external acquiring institution verify that the specific transaction corresponds with the financial transaction type described in the authorization; and
receive confirmation from the external acquiring institution that the specific transaction is authorized.

28. The system of claim 24, wherein the network interface is further configured to:
receive, from the user, a request that an additional requirement be imposed for using the token to complete a transaction,
wherein the processor is further configured to encode the additional requirement into the token.

29. The system of claim 28, wherein the network interface is further configured to:
receive, from a merchant, verification that the request to complete a specific transaction using the decoded token is made by a party that fulfills the additional requirement.

30. The system of claim 28, wherein the additional requirement comprises a requirement that the request to complete a specific transaction using the decoded token must be made by a party having specified credentials.

31. The system of claim 28, wherein the additional requirement comprises a limit on the number of times a token can be transferred.

32. The system of claim 24, wherein the network interface is further configured to:
receive, from the merchant, confirmation that the transaction is completed using the user's financial account; and
notify the user that the transaction was completed using the user's financial account.

33. The system of claim 24, wherein the processor is further configured to create a scanable code that represents the token, and wherein the network interface is further configured to send an instruction to an electronic device associated with the user, the instruction causing the electronic device to display a graphical element containing the scanable code.

34. A method comprising:
authenticating a cardholder in an online platform;
pre-authorizing a purchase amount on the cardholder's credit card account;
creating a token that points to the pre-authorized purchase amount and that can be used by a delegate to complete a purchase for up to the pre-authorized purchase amount.

35. The method of claim 34, further comprising receiving, from a merchant, a request to complete a transaction using the token.

36. The method of claim 35, wherein the token to naturally expire at a predetermined time, the method further comprising:
examining the token to determine that the token has expired; and
notifying the merchant that the token is not valid.

37. The method of claim 36 further comprising:
examining the token to determine that the token has been cancelled by the cardholder; and
notifying the merchant that the token is not valid.

38. The method of claim 36, further comprising
examining the token to determine that the token has been modified by the cardholder to require additional credentials; and
notifying the merchant that additional credentials are required to use the token.
